(19) United States
(12) Patent Application Publication
(10) Pub. No.: US 2008/0144769 A1
(43) Pub. Date: Jun. 19, 2008

(54) Device for irradiation therapy with image monitoring

(75) Inventor: Sebastian Schmidt, Weisendorf (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 12/002,948

(22) Filed: Dec. 18, 2007

(30) Foreign Application Priority Data
Dec. 18, 2006 (DE) 10 2006 059 707.9

(51) Int. Cl. G01N 23/04; G01V 3/00

(52) U.S. Cl. 378/63; 378/62; 324/307

(57) ABSTRACT

Device for irradiation therapy with image monitoring, comprising a magnetic resonance device and an irradiating device, with the magnetic resonance device including a C-shaped magnet having a yoke and two lateral pole shoes and with the irradiating device being arranged for feeding radiation from the open side into the region between the pole shoes.

A clean copy of the abstract that incorporates the above amendments is provided herewith on a separate page.

### CROSS REFERENCE TO RELATED APPLICATIONS

This application claims priority of German application No. 10 2006 059 707.9 filed Dec. 18, 2006, which is incorporated by reference herein in its entirety.

### FIELD OF THE INVENTION

The invention relates to a device for irradiation therapy with image monitoring, comprising a magnetic resonance device and an irradiating device.

### BACKGROUND OF THE INVENTION

The purpose of irradiation therapy is generally to irradiate a target inside the human body in order to combat diseases, particularly cancer, by generating a high radiation dose selectively in an isocenter of an irradiating device. The problem frequently arising therein is that the irradiation target inside the body can move. For example a tumor in the abdominal region will change its position over the course of breathing. It has therefore been proposed to check the position of the irradiation target inside the body during irradiating by means of imaging in order to appropriately control the beam or, where applicable, be able to stop irradiating. That is especially relevant in the case of irradiation targets in the upper and lower abdomen and in the pelvic region, for example the prostate.

Both X-ray and ultrasound devices have been proposed as the imaging medium. They do not, though, provide a practical solution to the problem since ultrasound lacks the depth of penetration required for numerous applications and X-ray sensors will be impaired or damaged by the gamma radiation of the accelerator.

That is why positioning aids and securing devices are chiefly employed today to insure that the patient maintains the same position in the irradiating device as in the irradiation plan and that the isocenter of the irradiating device will hence also actually coincide with the irradiation target. Said positioning aids and securing devices are, however, effort-intensive, fault-prone, and usually uncomfortable for the patient.

In GB 2 382 512 A it was proposed to integrate a magnetic resonance imaging device with an irradiating device. It is therein proposed to divide the solenoid magnet of the magnetic resonance device into two parts. Disadvantageous therein are the high costs due to the necessary bisecting of the magnet, since practically two magnets will be needed instead of one. The use of a conventional device is not possible.

The use of a known, serially produced solenoid magnet is for that reason alone scarcely possible since the beam of the irradiating device will be unfavorably attenuated and deflected by the magnet. Relevant solutions are discussed in, for example, GB 2 393 373 A, with the intention being to keep a central region of the solenoid magnet as field-free as possible. It would in turn be necessary to develop a device specifically for that application, although the market for irradiating devices is very small so that specially developed magnetic resonance imaging devices of said type appear not to be worthwhile.

### SUMMARY OF THE INVENTION

The object of the invention is therefore to disclose a device for irradiation therapy with image monitoring which with little structural design effort, in particular with the possibility of using serially produced magnetic resonance devices, will allow enabling of image monitoring by means of magnetic resonance during irradiating.

To achieve said object it is inventively provided in the case of a device of the type cited in the introduction for the magnetic resonance device to include a C-shaped magnet having a yoke and two lateral pole shoes and for the irradiating device to be arranged for feeding radiation from the open side into the region between the pole shoes.

A C-shaped magnet usually has—apart from the pole shoes and yoke—a side that is open particularly in three directions and which usually provides better access for positioning a patient, but which in the present invention serves additionally to insure interference-free irradiation through the irradiating device. The irradiating device is for that purpose arranged in such a way that its beam or beams will reach a body positioned in the magnetic resonance device without first passing through the yoke or pole shoes, or through other elements of the magnetic resonance device. C-arm magnets of said type are commonly known and available as serially produced items. They will require only slight modification to be able to be used in the inventive device. An economical, structurally simple solution is hence provided that will permit realtime image monitoring during irradiation therapy and additionally allow simpler patient positioning.

It will accordingly be possible by means of the inventive device to continuously check the position of the irradiation target during irradiating. If said position changes owing to, for example, breathing-induced displacement, then the beam can be appropriately compliantly adjusted. Suitable motion-correcting algorithms are used today for, for example, correcting motion in magnetic resonance recordings and are commonly known.

To enable a recording to be obtained that exhibits a sufficiently high resolution, the arrangement is expediently selected such that the isocenter of the irradiating device is located within the homogeneity volume of the magnetic resonance device, in particular within the isocenter of the magnetic resonance device. What is to be understood by the isocenter of the magnetic resonance device is in this case the point of maximum homogeneity which, in relation to the irradiating device, is the point at which different beams of the irradiating device, emitted possibly successively, meet.

Essentially two possibilities are conceivable for embodying the irradiating device. Thus the irradiating device can include an irradiating source mounted in a plane lying between the parallel pole shoes, in particular the mid plane, rotatably around the isocenter of the irradiating device. What is to be understood as the irradiating source is essentially the region of the irradiating device wherefrom the beams are ultimately emitted, for example the irradiating head. What is now inventively provided is an irradiating device having an irradiating source that can be rotated in such a way that the radiation can be fed from different directions from the open side into the region between the pole shoes. The orientation of the irradiating source is therein usually to be selected such that the beams will radiate in the plane of rotation. The mid point of rotational motion will then constitute the isocenter and can advantageously coincide with the isocenter of the magnetic resonance device. The magnetic field is in said type of embodiment perpendicular to the irradiating direction. The irradiating source can therein be rotatable through an angle of between 90° and 180°, in particular 120°. Albeit a 360° rotation will no longer be possible with the inventive device since obstructing of irradiating by the yoke is as far as possible to be prevented, a fairly small rotation angle will nonetheless suffice for most applications on the trunk area of the body.

In an alternative embodiment the irradiating device can include a plurality of irradiating sources which, particularly arranged along an arc, are oriented on an isocenter at different angles. The rotatability of an individual irradiating source will in that case accordingly no longer be provided; irradiating sources will instead be arranged at different angles. Their arrangement is expediently selected such that all beams of the irradiating sources will radiate in a plane between the parallel pole shoes, in particular the mid plane between said pole shoes.

The device for irradiation therapy with image monitoring can generally be embodied such that the pole shoes are oriented vertically, with a patient table being provided arranged above the yoke. In this embodiment the magnetic resonance device will as it were be tilted into a standing position so that the magnetic field will lie in the horizontal plane and the yoke underneath. The central position of, for example, a rotatable irradiating source of the irradiating device would then be in the middle above the magnetic resonance device. In this inventive variant the patient lies on a table above the yoke and can, where appropriate, place his/her arms outside the magnets, for example during an abdominal treatment.

In another embodiment the pole shoes can be oriented horizontally, with a patient table being provided arranged above the bottom pole shoe. The magnetic resonance device can in that case be in its customary position, with in particular a horizontal plane then being selected as the irradiating plane.

It is alternatively also possible to provide a swiveling device for swiveling the magnetic resonance device between a first position in which the pole shoes are oriented vertically and a second position in which the pole shoes are oriented horizontally. Said type of swiveling device can include, for example, hydraulic and/or pneumatic elements. Electric or electromagnetic repositioning is, of course, also conceivable. Whereas in the cases previously cited it was in certain circumstances necessary to position the patient on his/her side, a suitable position of the magnetic resonance device can now be selected. Alongside an embodiment in which it is possible only to move to the two end positions (horizontal or, as the case may be, vertical position), embodiment variants are also conceivable in which the magnetic resonance device can be halted at different angles. A tilting patient table is then, where applicable, additionally provided so that ultimately any irradiating directions will be enabled during irradiating. It is, of course, also conceivable for the magnetic resonance device to be used only for imaging in the horizontal position and, once irradiating has been provided, to be tilted into the vertical position. The irradiating device will then not need to be modified. If, though, irradiating is to be performed—in particular from different angles to the patient's body—in each case in both end positions or in any positions, then two embodiments are basically conceivable. The irradiating device can on the one hand include two irradiating sources, one of which is oriented horizontally and the other vertically; on the other hand an irradiating source of the irradiating device can be embodied as able to swivel from a horizontal to a vertical position and back and able to be halted at the required angular position.

In a particularly advantageous embodiment it can be provided for the magnetic resonance device and irradiating device to be able to be moved relative to each other, in particular by means of guide rails. It will then be possible, for example, for the magnetic resonance device to be removed from the region of the irradiating device so that either irradiating without image monitoring will be enabled or the magnetic resonance device can be used for imaging only, with no further space problems. The irradiating device can alternatively also be mounted movably. Although movement can be driven manually, there is expediently a drive unit present that will drive the movement of the movable device or devices automatically.

The magnetic resonance device can advantageously have a radiation shield for protecting the electronic components of the magnetic resonance device from the beams of the irradiating device. Said radiation shield can be located beneath a patient table or on the yoke. Locating it beneath the patient table will be expedient particularly in the case of an upright magnetic resonance device, meaning in the case of vertically oriented pole shoes.

The strength of the magnetic field of the magnetic resonance device can range from 0.2 to 0.4 T. That will enable image recordings of adequate quality. A magnetic resonance device having other specifications can, of course, also be used.

The irradiating device can be, for instance, a linear accelerator. Also conceivable, though, are irradiating devices having the nature of, in particular, a gamma knife.

The flow of therapeutic actions in an inventive device is customarily as follows. The patient is first positioned on a patient table in the magnetic resonance device. A magnetic resonance examination is then performed. The irradiation target can be seen in the ensuing recordings. There it is marked, either automatically or manually, and compared with the irradiation plan, for example by superimposing the images. The irradiation field or the patient's position will be adjusted accordingly if there are differences in position. Irradiating is then started. Magnetic resonance recordings are produced continuously during irradiating and the irradiation target's position is determined from said recordings—in particular automatically. The beam will be automatically compliantly adjusted if the irradiation target moves; the patient table can, where applicable, also be drivable to provide automatic positioning. It can furthermore be provided for irradiating to be stopped completely if a pre-specified threshold is exceeded.

### BRIEF DESCRIPTION OF THE DRAWINGS

Further advantages and specifics of the present invention will emerge from the exemplary embodiments described below and with reference to the drawings, in which:

FIG. 1 is a front view of an inventive device according to a first embodiment variant,

FIG. 2 is a side view of the inventive device according to the first embodiment variant,

FIG. 3 is a front view of an inventive device according to a second embodiment variant, and

FIG. 4 is a top view onto an inventive device according to the second embodiment variant.

### DETAILED DESCRIPTION OF THE INVENTION

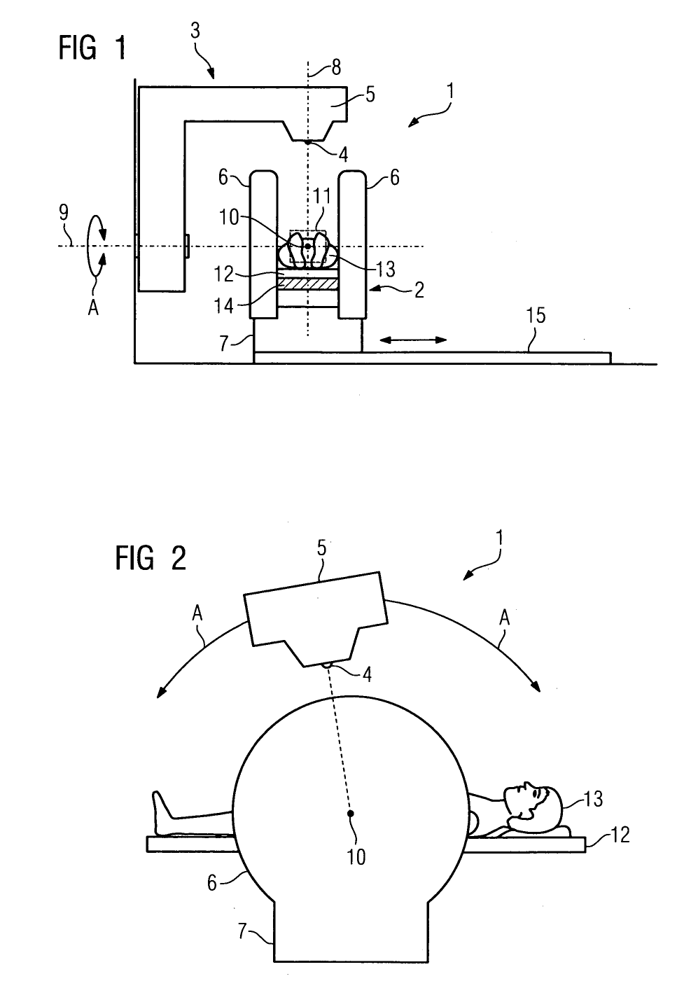

FIG. 1 and FIG. 2 show a device 1 for irradiation therapy with image monitoring. It includes a magnetic resonance device 2 and an irradiating device 3. The irradiating device 3, here a linear accelerator, includes an irradiating source 4 that is located on the head 5 and through which the radiation exits. The magnetic resonance device 2 includes a C-shaped magnet, which hence comprises two pole shoes 6 as well as a yoke 7 in the area of which electronic control elements are frequently also located. The irradiating device 3 is arranged in such a way that the radiation emanating from the irradiating source 4 will be radiated in between the pole shoes 6 of the magnetic resonance device 2 from the open side. The irradiating source 4 is therein oriented such that the radiation will radiate in the mid plane 8 between the two pole shoes 6.

The head 5 having the irradiating source 4 can be rotated around a rotational axis 9 through a total of 120°, as is indicated by the arrows A. It is consequently possible to irradiate from different directions in such a way that a radiation maximum is produced in the isocenter 10 of the irradiating device. Said isocenter is located within the homogeneity volume 11 of the magnetic resonance device 2 and coincides advantageously with the isocenter 10 of the magnetic resonance device 2.

The magnetic resonance device 2 further includes a patient table 12 located above the yoke 7. A patient 13 lying on said table on his/her back or side can be put into the magnetic resonance device 2. If the patient 13 is lying on his/her back, his/her arms will possibly be located outside the magnetic resonance device 2.

Located underneath the patient table 12, possibly on the yoke 7, is a shield 14 that protects the yoke and the therein contained electronic components of the magnetic resonance device 2 from radiation damage.

The magnetic resonance device 2 is further located on guide rails 15 that allow the magnetic resonance device 2 to be reversibly removed from the region of the irradiating device 3. That can be done either manually or else automatically by means of a drive unit that is not shown here. Further provided are halting means for halting the magnetic resonance device 2 at different positions.

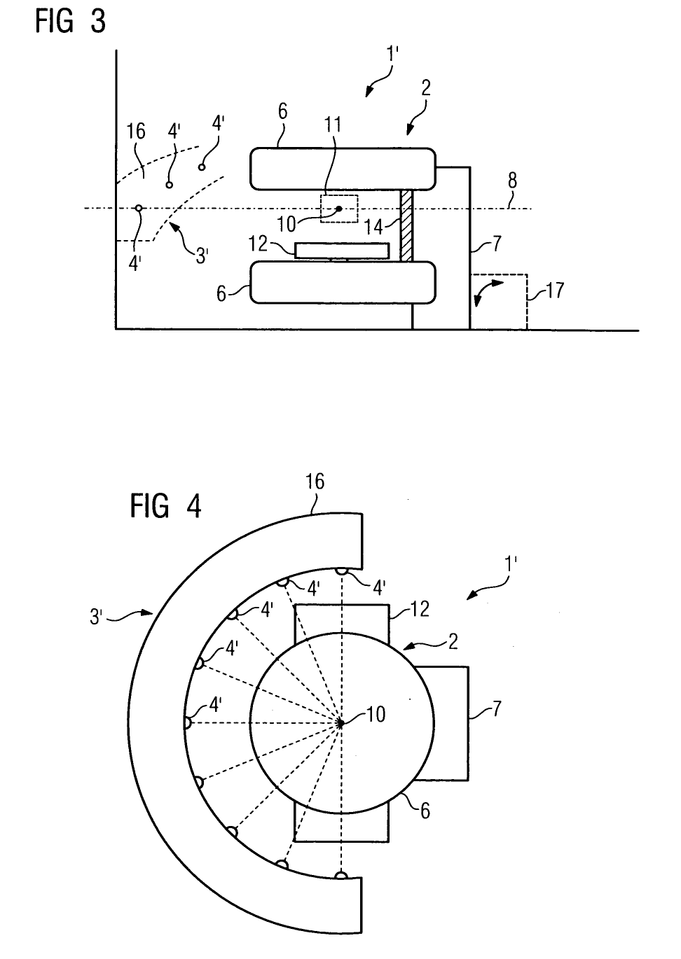

FIG. 3 and FIG. 4 show a second embodiment variant of a device 1′ for irradiation therapy with image monitoring, with the same components being referenced with the same reference numerals. FIG. 3 shows, like FIG. 1, a front view and FIG. 4 shows a top view.

It can be seen that the pole shoes 6 of the magnetic resonance device 2 are now arranged no longer vertically but horizontally. The patient table 12 has been positioned above the bottom pole shoe 6. The radiation shield 14 is now located directly on the yoke to protect both it and the electronic components from radiation.

The irradiating device 3′, of which only a part is shown in FIG. 3, includes an arc 16, with a plurality of irradiating sources 4′ being arranged along said arc 16 that are oriented such that their beams will meet in the mid plane 8 in the isocenter 10 that is located within the homogeneity volume 11 and advantageously coincides with the isocenter of the magnetic resonance device 2.

It is possible in either embodiment variant to additionally provide a swiveling device 17, expediently having hydraulic and/or pneumatic elements, that serves to swivel the magnetic resonance device 2 between a first position in which the pole shoes 6 are oriented vertically (see FIG. 3) and a second position in which the pole shoes 6 are oriented horizontally (compare FIG. 1). For clarity's sake the swiveling device 17 is shown only in FIG. 3 in dashed outline. The irradiating device 3′ in the second exemplary embodiment can analogously thereto also be embodied as swiveling and the patient table 12 as tilting so that irradiating of the body at different angles is enabled. In the case of a linear accelerator it is also conceivable to provide a second irradiating source which—in contrast to the irradiating source 4 shown in FIG. 1—radiates in the horizontal plane. Tilting can take place only between the first position and second position, although halting of the magnetic resonance device 2 and, where applicable, the irradiating device 3 or 3′ at different angles is also conceivable.

The magnetic resonance device 2 has a field strength of 0.3 T, although other field strengths, in particular between 0.2 and 0.4 T, are conceivable also. Magnetic resonance devices having larger or smaller fields can, though, also be used.

1.-15. (canceled)

16. A device for performing an irradiation therapy, comprising:
a magnetic resonance device that comprises a C-shaped magnet having a yoke and two lateral pole shoes; and
an irradiating device that feeds an radiation from an open side of the C-shaped magnet into a region between the pole shoes.

17. The device as claimed in claim 16, wherein the irradiating device comprises an irradiating source that is mounted in a plane between the pole shoes and can rotate around an isocenter of the irradiating device.

18. The device as claimed in claim 17, wherein the plane is a mid plane between the pole shoes.

19. The device as claimed in claim 17, wherein the irradiating source is rotatable through an angle between 90° and 180°.

20. The device as claimed in claim 17, wherein the irradiating source is rotatable through an angle between 90° and 120°.

21. The device as claimed in claim 16, wherein the irradiating device comprises a plurality of irradiating sources that are oriented at different angles for radiating a plane between the pole shoes.

22. The device as claimed in claim 21, wherein the irradiating sources are arranged along an arc about an isocenter of the irradiating device.

23. The device as claimed in claim 16, wherein an isocenter of the irradiating device is located within a homogeneity volume of the magnetic resonance device.

24. The device as claimed in claim 16, wherein the pole shoes are oriented vertically and a patient table is arranged above the yoke.

25. The device as claimed in claim 16, wherein the pole shoes are oriented horizontally with one at a bottom and one at a top and a patient table is arranged above the bottom pole shoe.

26. The device as claimed in claim 16, further comprising a swiveling device that swivels the magnetic resonance device between a first position in which the pole shoes are oriented vertically and a second position in which the pole shoes are oriented horizontally.

27. The device as claimed in claim 26, wherein the swiveling device comprises an element selected from the group consisting of: a hydraulic element, a pneumatic element, an electric element, and an electromagnetic element.

28. The device as claimed in claim 16, wherein the irradiating device comprises one horizontal irradiating source and one vertical irradiating source or an irradiating source that can swivels back and forth from a horizontal position to a vertical position.

29. The device as claimed in claim 16, wherein the magnetic resonance device and the irradiating device can be moved relative to each other.

30. The device as claimed in claim 29, wherein the magnetic resonance device or the irradiating device is moved by a guide rail.

31. The device as claimed in claim 16, wherein the magnetic resonance device comprises a radiation shield located beneath a patient table or on the yoke for protecting an electronic component of the magnetic resonance device from the radiation of the irradiating device.

32. The device as claimed in claim 16, wherein a magnetic field of the magnetic resonance device has a strength in a range of 0.2T to 0.4 T.

33. The device as claimed in claim 16, wherein the irradiating device is a linear accelerator.

34. The device as claimed in claim 16, wherein the irradiation therapy is monitored by the magnetic resonance device.

35. A method for performing an irradiation therapy with imaging monitoring, comprising:
monitoring a target of a patient to be irradiated by a magnetic resonance device comprising a C-shaped magnet having a yoke and two lateral pole shoes; and
irradiating the target from an open side of the C-shaped magnet into a region between the pole shoes.
